(19) United States
(12) Patent Application Publication
(10) Pub. No.: US 2009/0277921 A1
(43) Pub. Date: Nov. 12, 2009

(54) Apparatus and Methods for Dispensing Items

(75) Inventors: Karen Angelucci, Bridgeport, PA (US); Brian D. Johnson, Landenberg, PA (US); Michael L. Forehand, Avondale, PA (US); Janice Jackson, Chaddsford, PA (US); Dave Trapani, West Chester, PA (US); Adele Gulfo, New York, NY (US); Kathy Monday, Glen Mills, PA (US); Dean Whitney, Newton, MA (US); Peter K. Bates, Framingham, MA (US); Alan Mudd, Beverly, MA (US)

Correspondence Address: Weiss & Arons, LLP, 1540 Route 202, Suite 8, Pomona, NY, 10970, US

(73) Assignee: AstraZeneca AB, Sodertalje (SE)

(21) Appl. No.: 12/117,073

(22) Filed: May 8, 2008

(51) Int. Cl. G07F 11/62; B65D 45/16

(52) U.S. Cl. 221/25; 220/324

(57) ABSTRACT

An item dispenser and methods for dispensing the item. In some embodiments of the invention, the item dispenser may include a housing, an item carriage, and a movable support. The movable support may be indexed to position the item carriage at (1) a first position in which the item carriage is positioned to release only a first item; and (2) a second position in which the item carriage is positioned to release a second item. In some embodiments of the invention, the dispenser may include a housing, a pivotable cap and a snap fastener. The snap fastener may extend from the cap to the housing and engage the housing to lock the cap in the closed position. The cap may be opened by moving an interference block away from a snap fastener lever.

### BACKGROUND

This application relates to an item dispenser in which items are dispensed from a container. In particular, the application relates to a dispenser for solid dosage forms, which may include pills, compacts, capsules and caplets.

Individuals with limited or compromised dexterity, with limited or compromised faculties, or with a combination thereof, may have difficulty administering solid dosage forms to themselves. Also, the individuals may have difficulty complying with dosage timing requirements. Solid dosage forms are often provided in bottles in which many doses are stored in an aggregate. Whereas such bottles may have sufficiently wide mouths to provide access to multiple fingers, the doses must be separated and administered individually. Also, such aggregates do not provide a means of keeping track of dosing information such as times for future administration of the solid dosage forms and times of past administration of the solid dosage forms.

In contrast, individualized packaging, such as blister packs or egg-carton style dispensers, which may include partitions for storing different dosage forms for administration at different times, often require dexterity and strength to extract the dosage forms.

Furthermore, it is often difficult to provide dispensing apparatus for adults of limited dexterity and strength without making solid dosage forms available to the children.

It would be desirable, therefore, to provide apparatus and methods for dispensing solid dosage forms in a manner that facilitates dispensing of solid dosage forms.

It would also be desirable, therefore, to provide apparatus and methods for dispensing solid dosage forms in a manner that facilitates dispensing of solid dosage forms and reduces the likelihood that the solid dosage forms will be dispensed by a child.

It also would be desirable, therefore, to provide apparatus and methods for dispensing solid dosage forms in a manner that facilitates compliance with a therapeutic regimen.

### SUMMARY OF THE INVENTION

Solid dosage form dispensers and methods for dispensing solid dosage forms are provided. In some embodiments of the invention, the solid dosage form dispenser may include a housing, a cap and a snap fastener. The cap may be pivotably attached to an open end of the housing. The cap may pivot between a closed position (in which the housing is closed) and an open position (in which the housing is open). The snap fastener may extend from the cap to the housing and engage the housing to lock the cap in the closed position. The cap may include a clearance arch to provide room inside the cap for a solid dosage form carriage when the cap is in the closed position.

In some embodiments of the invention, the solid dosage form dispenser may include an elongated housing, a conveyor belt, and a conveyor belt support member. The housing may have an opening at an end. The conveyor belt may guide at least a portion of a solid dosage form carriage across the opening for dispensing the solid dosage form and retiring the solid dosage form carriage after dispensing the solid dosage form. The solid dosage form carriage may be affixed to the conveyor belt. The conveyor belt may be subject to a tension that is generated by the conveyor belt support member.

In some embodiments of the invention, the solid dosage form support member may include a housing, a solid dosage form carriage, and a movable support. The movable support may support the solid dosage form carriage. The movable support may be attached to the housing and being movable within the housing. The movable support may be indexed to position the solid dosage form carriage at (1) a first position in which the solid dosage form carriage is positioned to release only a first solid dosage form; and (2) a second position in which the solid dosage form carriage is positioned to release a second solid dosage form.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 is a front perspective view of apparatus in accordance with the principles of the invention;

FIG. 2 is a front perspective view of other apparatus in accordance with the principles of the invention;

FIG. 3 is a front perspective view of still other apparatus in accordance with the principles of the invention;

FIG. 4 is a front perspective view of yet other apparatus in accordance with the principles of the invention;

FIG. 5 is a rear perspective view of the apparatus of FIG. 4;

FIG. 6 is a front perspective view of a portion of the apparatus of FIG. 4;

FIG. 7 is a rear perspective view of yet other apparatus in accordance with the principles of the invention;

FIG. 8 is a front perspective view of yet other apparatus in accordance with the principles of the invention;

FIG. 9 is a front view of yet other apparatus in accordance with the principles of the invention;

FIG. 10 is a front view of the apparatus of FIG. 9 in a different state than the state shown in FIG. 9;

FIG. 11 is a front perspective view of yet other apparatus in accordance with the principles of the invention;

FIG. 12 is a top perspective view of a portion of the apparatus of FIG. 11 when the apparatus is in a different state than the state shown in FIG. 11;

FIG. 13 is a perspective view of a portion of the apparatus of FIG. 11;

FIG. 14 is a simplified version of a cross-sectional view taken along lines 14-14 of FIG. 13;

FIG. 15 is a front perspective view of a portion of the apparatus of FIG. 11;

FIG. 16 is a rear perspective view of the apparatus of FIG. 15;

FIG. 17 is a front perspective view of the apparatus of FIG. 11 when the apparatus is in a different state than the state shown in FIG. 11; and

FIG. 18 is cross-sectional view taken along lines 18-18 of FIG. 11.

### DETAILED DESCRIPTION OF EMBODIMENTS

Solid dosage form dispensers and methods for dispensing solid dosage forms are provided. In some embodiments of the invention, the solid dosage form dispenser may include a housing, a cap and a snap fastener. The cap may be pivotably attached to an open end of the housing. The cap may pivot between a closed position (in which the housing is closed) and an open position (in which the housing is open). The snap fastener may extend from the cap to the housing and engage the housing to lock the cap in the closed position. The cap may include a clearance arch to provide room inside the cap for a solid dosage form carriage when the cap is in the closed position.

In some embodiments of the invention, the solid dosage form dispenser may include an elongated housing, a conveyor belt, and a conveyor belt support member. The housing may have an opening at an end. The conveyor belt may guide at least a portion of a solid dosage form carriage across the opening for dispensing the solid dosage form and retiring the solid dosage form carriage after dispensing the solid dosage form. The solid dosage form carriage may be affixed to the conveyor belt. The conveyor belt may be subject to a tension that is generated by the conveyor belt support member.

In some embodiments of the invention, the solid dosage form support member may include a housing, a solid dosage form carriage, and a movable support. The movable support may support the solid dosage form carriage. The movable support may be attached to the housing and being movable within the housing. The movable support may be indexed to position the solid dosage form carriage at (1) a first position in which the solid dosage form carriage is positioned to release only a first solid dosage form; and (2) a second position in which the solid dosage form carriage is positioned to release a second solid dosage form.

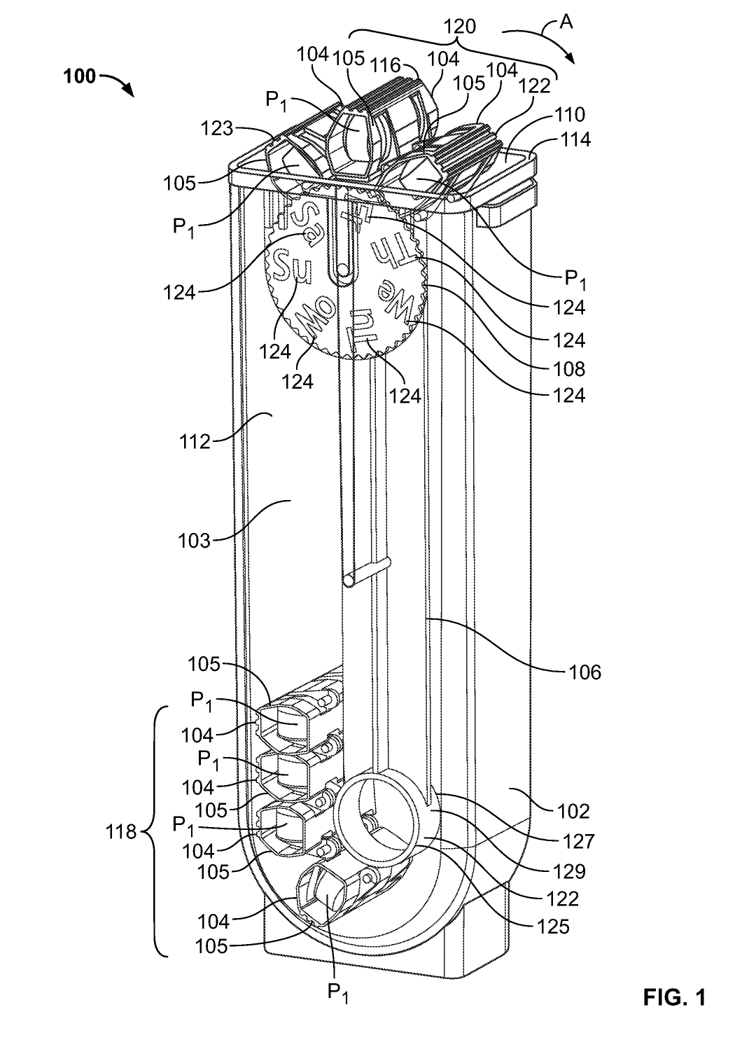

FIGS. 1-18 show illustrative embodiments and features of the invention.

FIG. 1 shows illustrative dispenser 100. Dispenser 100 may include housing 102. Dispenser 100 may include solid dosage form carriages 104. Each carriage 104 may be configured to transport a solid dosage form “P₁” (hereinafter, referred to as a pill, for the sake of simplicity) from enclosed portion 103 of housing 102 through opening 110 of housing 102. Each carriage 104 may have an opening 105 and a closed back end (not shown). In enclosed portion 103 of housing 102, a pill P₁ is retained inside its carriage 104 by contact with the inside surface of front wall 112 of housing 102. Pill P₁ may be dispensed from a carriage 104 when the carriage transports the pill past rim 114 of housing 102 and through opening 110. Carriage 116 in FIG. 1 is shown in a position in which its pill P₁ is free to be dispensed.

Carriages 104 may be linked together in a continuous chain (not shown in full) that is supported in an elongated path by support 106. FIG. 1 shows chain portions 118 and 120. Chain portion 118 is near bottom end 122 of support 106. Chain 120 is near the top end (not shown) of support 106. A user may operate dispenser 100 by moving carriage 116 in direction A.

When carriage 116 is moved in direction A, carriage 116 pulls the entire carriage chain along its path. The indexing mechanism may stabilize the chain after a discrete amount of movement along the path. After the discrete amount of movement, carriage 116 will have moved into the position of carriage 122. Carriage 122 will move toward enclosed portion 103 of housing 102. Carriage 123 will move into the position that carriage 116 occupies in FIG. 1. Carriages 104 thus transport pills through opening 110 for dispensing. After dispensing, carriages 104 may return to enclosed portion 103 of enclosure 102.

Dispenser 100 may include a mechanical linkage (not shown) for advancing indicator 108. Indicator 108 may be indexed in coordination with carriages 104 so that symbols 124, which as illustrated in FIG. 1 represent days of the week, advance in accordance with the dispensing of pills P. Indicator 108 may thus help a user comply with a drug therapy regimen.

Carriages 104 may have any suitable shape. FIG. 1 shows carriages 104 as having an eight-sided cross-section. The outermost surfaces may be at least partially textured for ease of manual manipulation.

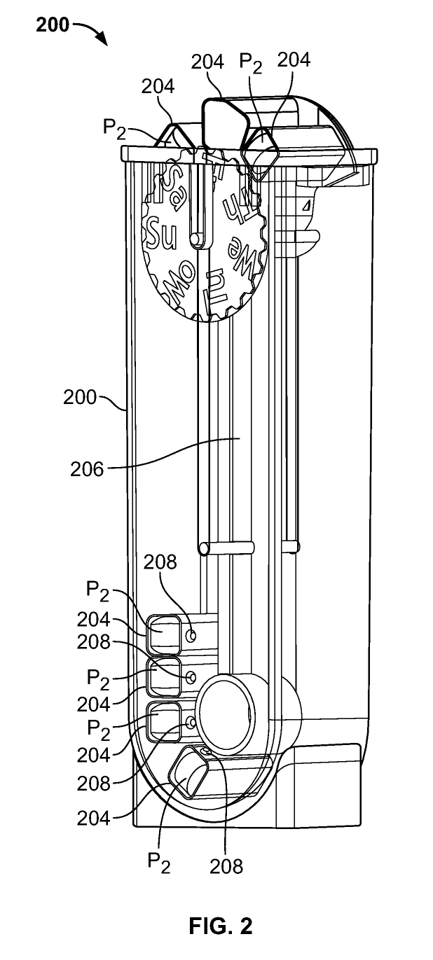

FIG. 2 shows illustrative dispenser 200. Dispenser 200 may include carriages 204, which may have features that correspond to those of carriages 104 (shown in FIG. 1). Carriages 204 have four-sided cross sections for holding pills P₂. Carriages 204 may not be linked directly to each other as are carriages 104. Instead, carriages 204 may be fixed to a conveyor member (not shown) that moves along an elongated path around support structure 206. Each of carriages 204 may include any suitable structure, such as structures 208 for attachment to the conveyor member.

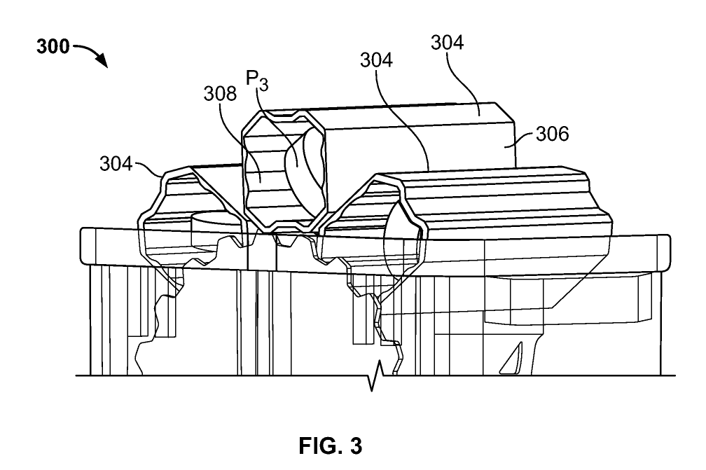

FIG. 3 shows a portion of illustrative dispenser 300. Dispenser 300 may include carriages 304. Carriages 304 may correspond to carriages 104 (shown in FIG. 1). Carriages 304 may have outside surfaces such as 306 and inside surfaces such as 308. Outside surface 306 may have an appropriate number of facets. The facets on outside surface 306 may be arranged to provide traction for a user to move carriages 304 in direction A. The facets on outside surface 306 may be arranged to accommodate the motions of adjacent carriages 304. Inside surface 308 may have facets that are arranged to accommodate a pill such as pill P₃. The facets on inside surface 308 may be arranged to maintain a press-fit between carriages 304 and pill P₃. The press fit may have any suitable tightness. In some embodiments, the press-fit may allow pill P₃ to slide out of carriages 304. In some embodiments, the press-fit may be sufficiently tight to require a user to pull pill P₃ out of carriages 304.

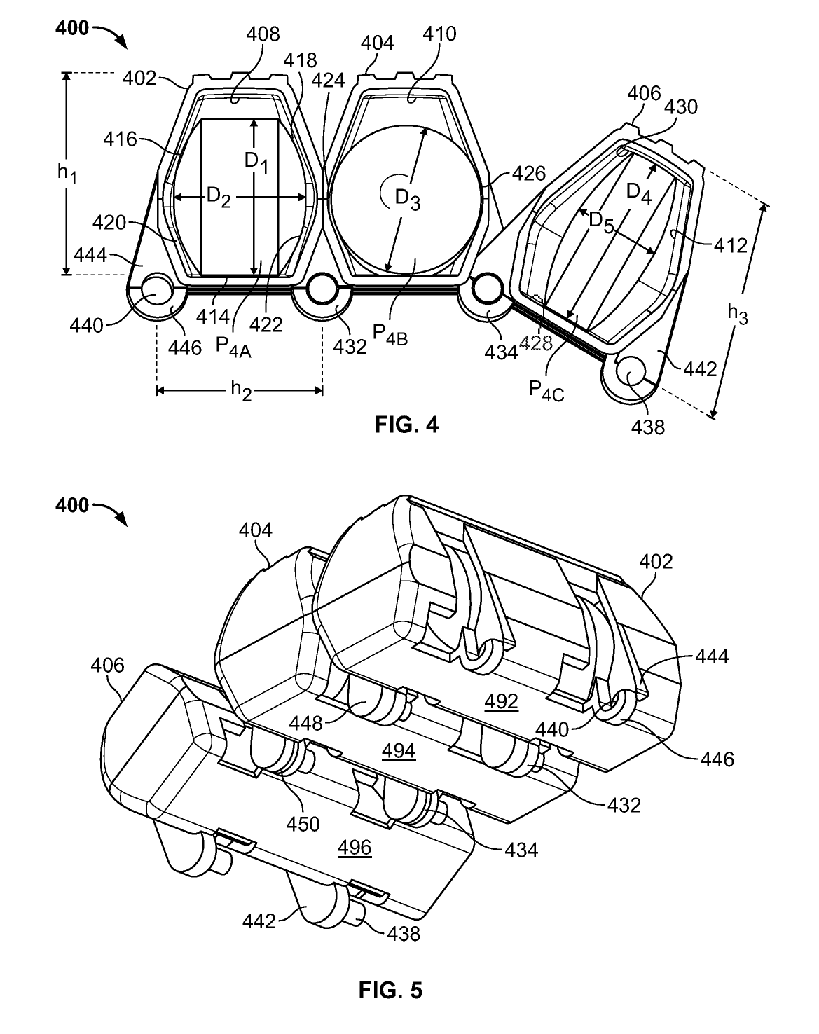

FIG. 4 shows partial carriage chain 400. Partial carriage chain 400 includes carriages 402, 404 and 406. Carriages 402, 404 and 406 are configured to transport pills P_{4A}, P_{4B} and P_{4C}, respectively. Carriages 402, 404 and 406 have inner surfaces 408, 410 and 412, respectively. Inner surfaces 408, 410 and 412 are contoured, at least partially, to portions of the corresponding pills P_{4A}, P_{4B} and P_{4C}.

For example, pill P_{4A} has diameter D₁ and diameter D₂. Inner surface 408 has corresponding dimensions h₁ and h₂. Although there is a general correspondence between D₁ and h₁, and between D₂ and h₂, FIG. 4 shows that pill P_{4A} is in contact (or nearly in contact) with inner surface 408 only along carriage base 414 and at fit points 416, 418, 420 and 422. Dimensions h₁ and h₂, and the curvature of inner surface 408 can be selected for an appropriate closeness of fit between inner surface 408 and pill P_{4A}.

Pill P_{4B} may have diameter D₃. Carriage 404 may have dimensions h₁ and h₂ to accommodate diameter D₃. Inner surface 410 of carriage 404 may be closely contoured at arcs 424 and 426 to match the curvature of pill P_{4B}. In some embodiments, inner surface 410 may include fit points or fit areas corresponding to fit points 416, 418, 420 and 422 of carriage 402.

Pill P_{4C} has diameters D₄ and D₅. Dimension h₃ of inner surface 412 corresponds to dimension h₃ so that pill P_{4C} contacts or nearly contacts inner surface 412 at carriage base and carriage ceiling 430. When appropriate, a carriage chain may include carriages of different shapes, as does partial chain 400. Carriage chains that include carriages of different shapes may be used to manufacture solid dosage dispensers that dispense pills of different shapes. This may be desirable when a drug therapy regimen includes different types of drugs, pills of different shapes, or pills of different dosages.

Partial carriage chain 400 includes hinges 432 and 434. Hinges 432 and 434 connect carriages 402 to 404 and 404 to 406. Hinges 432 and 434 include pins such as 438 and split rings such as 440. Carriages 402, 404 and 406 may include webs such as 442 (on carriage 406) and 444 (on carriage 402). Web 442 supports pin 438. Web 444 supports a top portion of ring 440. Bottom portion 446 of ring 440 extends from carriage 402 near the bottom of carriage 402.

FIG. 5 shows partial carriage chain 400 from behind. FIG. 5 shows webs 442 and 444, pin 438 and split ring 440. Hole 440 is formed by the arrangement of flange 444 and bottom portion 446. FIG. 5 also shows hinges 432 and 434. Hinges 432 and 434 are formed by the insertion of pins such as 438 into corresponding split rings, such as 440. Hinges 432 and 434 may be part of a “front” set of hinges. Carriage 400 may include a “back” set of hinges, such as hinges 448 and 450.

Carriages 402, 404 and 406 may include, respectively, bottom surfaces 492, 494 and 496. Bottom surfaces 492, 494 and 496 may slide along portions of a carriage chain support such as 106. Hinges such as 434 and 438 may operate, respectively, as guides on edges of support 106. For example, hinges 434 may guide carriage 404 along front edge 125 and rear edge 127 of bottom end 122 of support 106 (shown in FIG. 1). Bottom surface 494 of carriage 404 may slide along cylindrical surface 125 of bottom end 122.

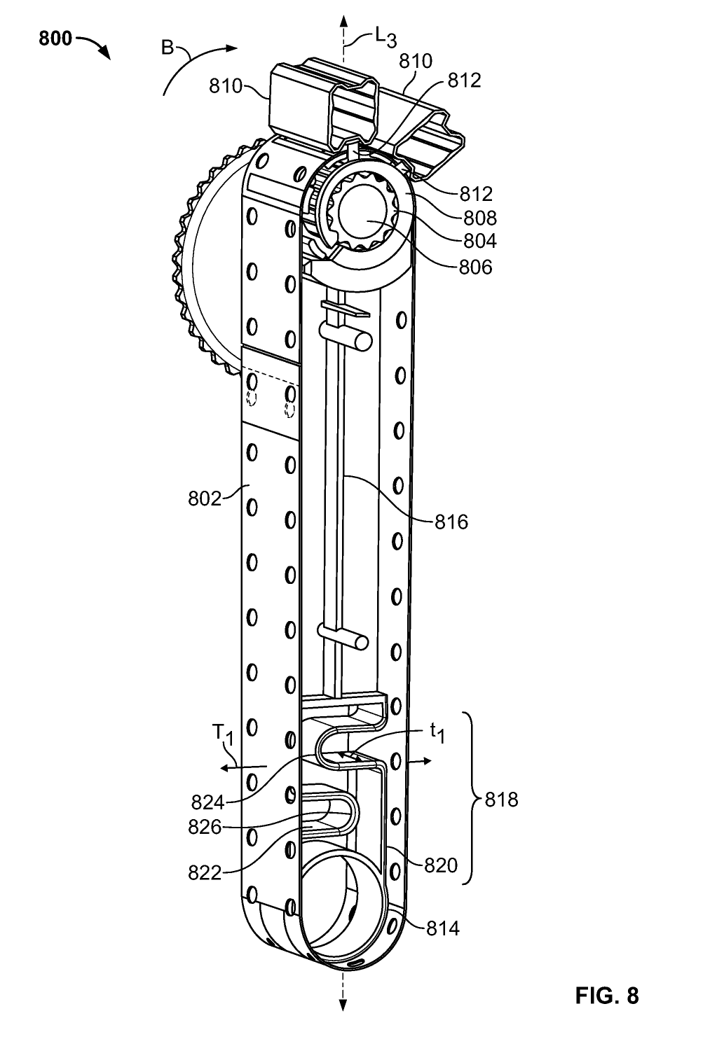

In some embodiments of the invention an intermediate belt (not shown) may be present between bottom surface 494 and support 106. The intermediate belt may form a loop that is present between support 106 and a carriage chain. In some embodiments of the invention, the intermediate belt may be fixed to support 106 and provide a sliding surface for bottom surfaces such as carriage bottom 494. In some embodiments, carriages may be fixed to the intermediate belt. In those embodiments, the intermediate belt may be configured to slide against support 106. (An illustrative intermediate belt is described below in configuration with FIG. 8.)

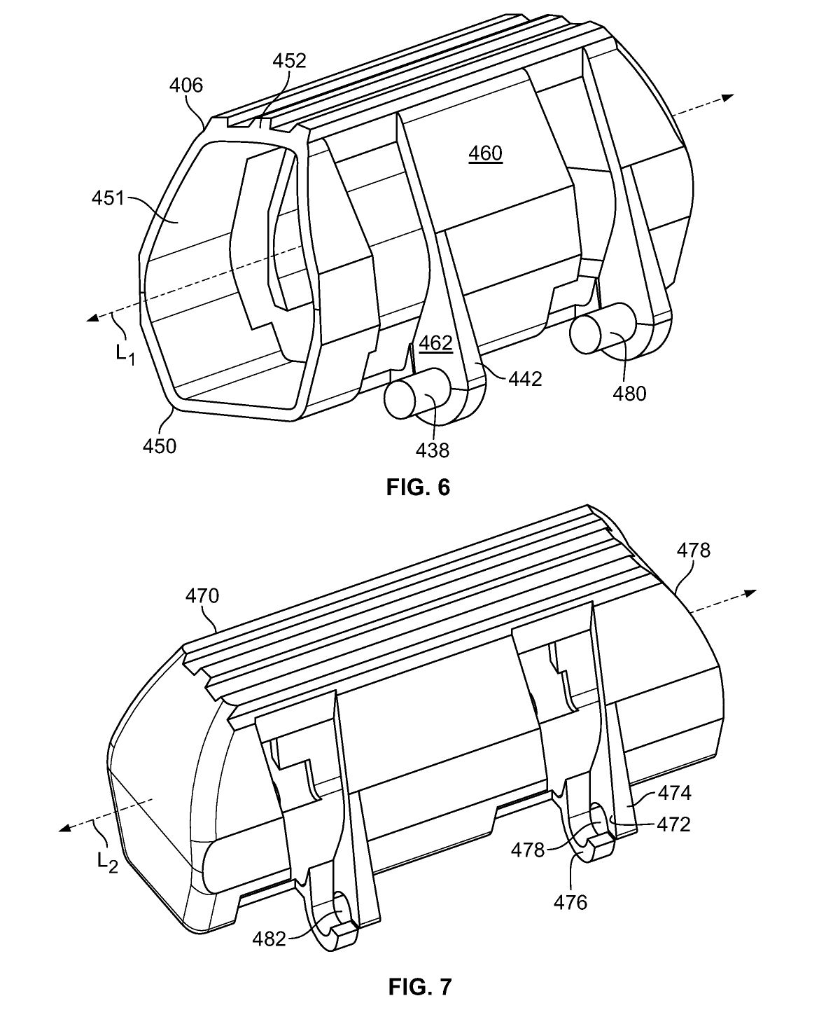

FIG. 6 shows a view of front end 450 of carriage 406. Front end 450 includes opening 451 and rim 452. Rim 452 may be planar or nonplanar, as shown. Rim 452 may have any suitable attitude relative to longitudinal axis L₁ of carriage 406. Flange 442 extends from side 460 of carriage 406. Pin 438 is supported by, and extends forward from, front face 462 of flange 442. In operation, front face 462 of flange 442 is butted against rear face 472 of flange 474 (both shown in connection with carriage 470 in FIG. 7).

FIG. 7 shows illustrative carriage 470 from behind. Carriage 470 may be attached at side 460 of carriage 406 (shown in FIGS. 4-6). Flange 474 and extension 476 together form split ring 478. Split ring 478 may receive pin 438 (shown in FIG. 6). When pin 438 is inserted in split ring 478, and face 462 of carriage 406 (shown in FIG. 6) is butted against face 472, longitudinal axes L₁ of carriage 406 and L₂ of carriage 470 may be substantially parallel. In that configuration, front end 478 of carriage 470 may be substantially even, in the longitudinal direction (parallel to L₁ and L₂), with front end 450 of carriage 406 (shown in FIG. 6). Also in that configuration, pin 438 of carriage 406 may be inserted in split ring 482 of carriage 470.

Carriage chains that are linked to each other as set forth above, or in any other suitable manner, may be supported by a chain support member such as 106 (shown in FIG. 6).

FIG. 8 shows illustrative conveyor assembly 800 for a solid dosage form dispenser. Assembly 800 may include intermediate belt 802. Intermediate belt 802 may be supported at the top by gear 804. Gear 804 may rotate on drum 806. Drum 806 may be rotatably fixed to a housing such as 102 (shown in FIG. 1). Gear 804 may be indexed by indexing coil spring 808. Carriages 810 may be fixed to intermediate belt 802 by brackets 812.

Intermediate belt 802 may be supported at the bottom by cylinder 814. Intermediate belt 802 may slide along the outer cylindrical surface of cylinder 814. Cylinder 814 may be held apart from top gear 804 by static support 816 and dynamic support 818. Intermediate belt 802 may be selected to have a length such that when intermediate belt 802 is supported by gear 804 and cylinder 814, dynamic support 818 compresses elastically and creates tension in intermediate belt 802. The tension may help keep intermediate belt 802 in sliding contact with cylinder 814. Dynamic support 818 may include leg 820 and complementary leg 822 (shown in part).

Bends 824 and 826, in legs 820 and 822, respectively may compress in a direction parallel to L₃ to create the aforementioned tension. Bends 824 and 826 may substantially maintain the tension required to keep intermediate belt 802 in contact with cylinder 814 during operation of conveyor assembly 800. During operation, a user may urge one or more of carriages 810 in direction B to dispense a pill (not shown). Without dynamic support 818, such operation might deform intermediate belt 802 such that intermediate belt 802 would be urged off of cylinder 814. Compression or extension of dynamic support 818, in response to the operation, may prevent the deformation from causing intermediate belt 802 to lose contact with cylinder 814.

Legs 820 and 822 may be spaced apart from each other to resist torsion around longitudinal axis L₃. Legs 820 and 821 may have a thickness such as t₁ to resist torsion around axis L₃. Thickness t₁ may also resist flexion around transverse axis T₁.

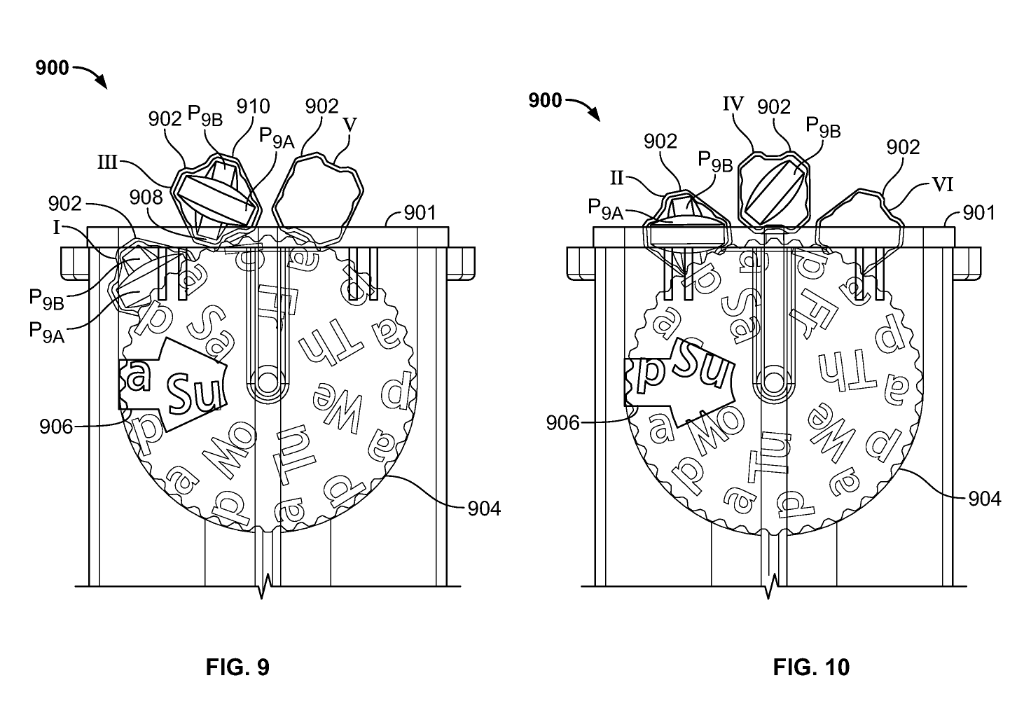

FIGS. 9 and 10 show illustrative solid dosage form dispenser 900 in Stages I-VI of operation. The Stages correspond to different positions of single solid dosage form carriage 902. Solid dosage form carriage 902 is configured to hold pill P_{9A} in on orientation and pill P_{9B} in another orientation. When carriage 902 advances, first pill P_{9A} moves beyond dispenser rim 901. Pill P_{9A} can then be dispensed. Second, pill P_{9B} moves beyond dispenser rim 901. Pill P_{9B} can then be dispensed. Indicator 904 includes indications of the days of the week (“Su,” “Mo,” “Tu,” “We,” “Th,” “Fr” and “Sa”). For each day of the week, indicator 904 includes an indication of the part of the day (“am”, “pm”). The day and part of day corresponding to an active Stage are shown in window 906.

The Stages may be characterized, at least partially, as follows:

| | Status | | |
|---|---|---|---|
| | | | Indicator |
| Stage | Pill P_{9A} | Pill P_{9B} | 904* |
| I | Retained below rim 901 | Retained below rim 901 | N/A |
| II | Retained at rim 901 | Retained by pill P_{9A} | N/A |
| III | Released | Retained by rim 901 | Sunday AM |
| IV | — | Released | Sunday PM |
| V | — | — | N/A |
| VI | — | — | N/A |

*Status tabulated only insofar as the dispensing of P_{9A} and P_{9B} are concerned.

At Stage III, channels 908 and 910 prevent pill P_{9B} from rotating within carriage 902. Because pill P_{9B} is unable to rotate, it continues to be retained inside carriage 902 by rim 901.

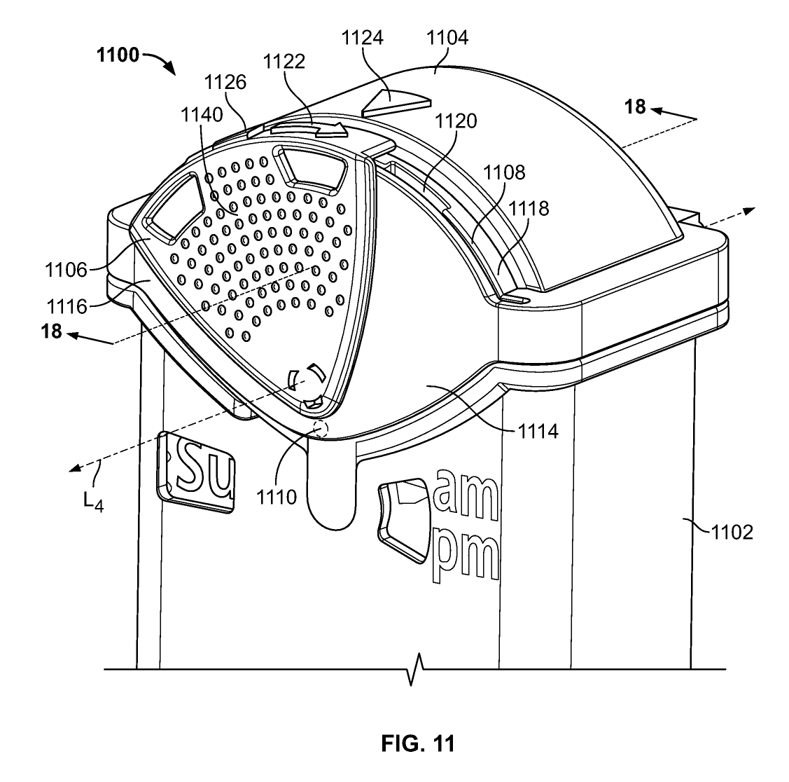

FIG. 11 shows a portion of illustrative solid dosage form dispenser 1100. Dispenser 1100 may include housing 1102. Dispenser 1100 may include locking cap 1104. Cap 1104 may be hinged (hinge not shown) to housing 1102. Cap 1104 may include snap fastener 1110 (shown in broken line) to lock cap 1104 to housing 1102. (FIG. 18, which is discussed below, shows snap fastener 1110 engaged with receptacle 1190 of housing 1102.)

Cap 1104 may include rotating slider 1106, front face 1114 and track 1108. Track 108 may include main course 1118 and one or more side bays such as side bay 1120.

Rotating slider 1106 may rotate, in front of front face 1114, about axis L₄. Rotating slider 1106 may include one or more blades (not shown) that travel in track 1108 as rotating slider 1106 rotates around axis L₄. When snap fastener 1110 is engaged with housing 1102, snap fastener 1110 may be disengaged from housing 1102 by compressing track 1108. Compression of track 1108 moves front face 1114 toward the back of dispenser 100 and levers snap fastener 1110 away from housing 1102, because there is a fulcrum (not shown) behind front face 1114.

In FIG. 11, dispenser 1100 is shown in the closed and locked position. Slider 1106 may be biased to left side 1116 of front face 1114. In that position, the blades (not shown) may be located in main course 1118 of track 1108. When the blades are in main course 1118, track 1108 cannot be compressed. When track 1108 cannot be compressed, snap fastener 1110 cannot be disengaged from receptacle 1190 in housing 1102.

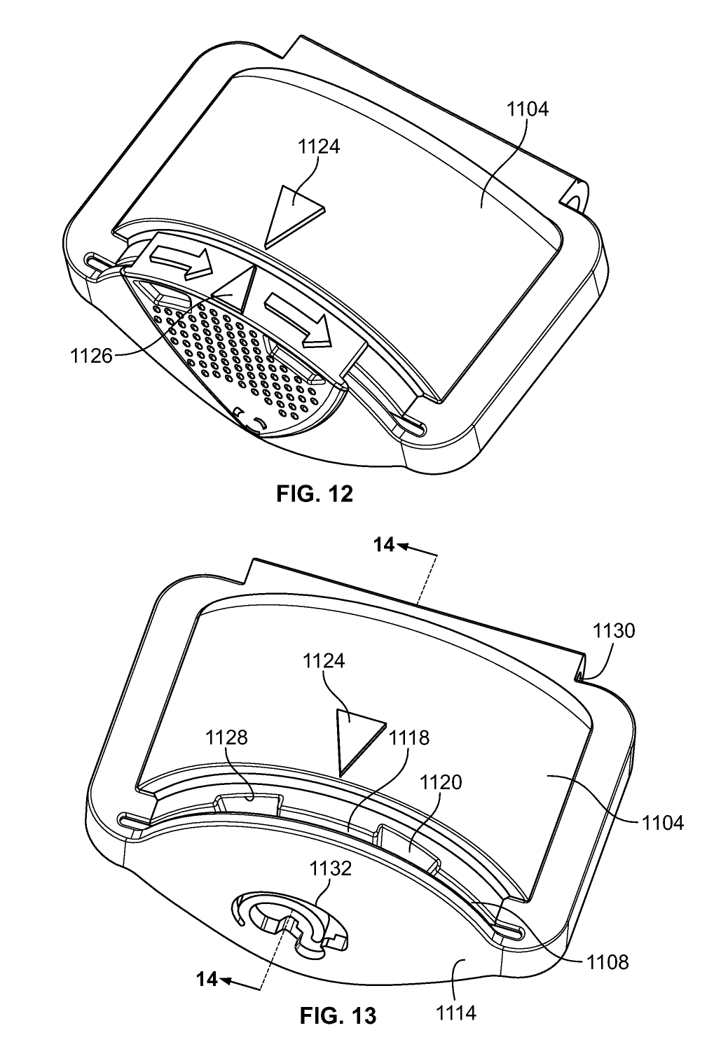

Dispenser 1110 may be unlocked by sliding slider 1106 in the direction of arrow 1122 until each blade (not shown) is aligned with a side bay in track 1108. When each blade is aligned with a side bay, track 1108 can be compressed and snap fastener 1110 can be disengaged from housing 1102. Dispenser 1110 includes alignment indicia 1124 and 1126 on the top of cap 1104 and on the top of slider 1106, respectively. When indicia 1124 and 1126 are aligned with each other, the blades are aligned with respective side bays in track 1108 and cap 1104 can be opened. (FIG. 12 shows cap 1104 when indicia 1124 and 1126 are aligned with each other.)

Track 1108 may be compressed manually. For example, a user may hold housing 1102 in his hand and press on textured region 1140 of slider 1106. The user may press on textured region 1140 while holding slider 1106 so that indicia 1124 and 1126 are aligned with each other.

FIG. 13 shows cap 1104 without slider 1106. FIG. 13 shows that track 1108 may include side bays 1120 and 1128. Cap 1104 may be fixed to housing 1102 by hinge 1130. Front face 1114 may include any suitable structure, such as rotation guide track 1132, for engaging slider 1106 in a manner that allows slider 1106 to rotate about axis L₄ (shown in FIG. 11 and approximately collinear with line 14-14 in FIG. 13).

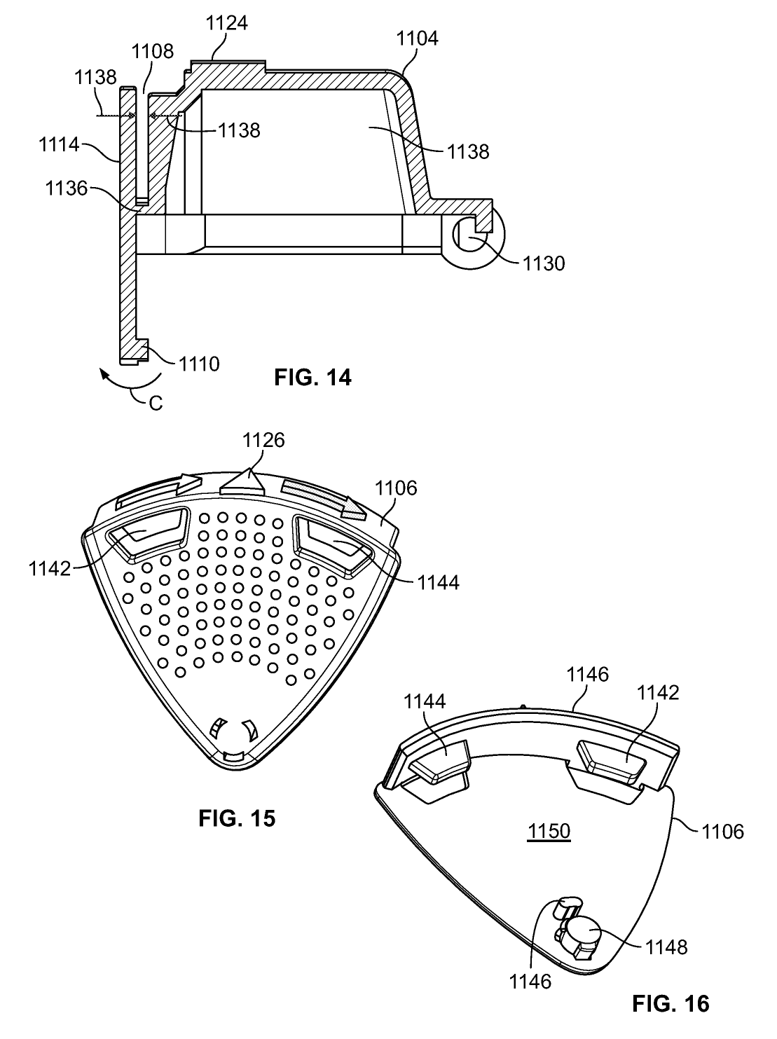

FIG. 14 is a partial cross-sectional view taken along lines 14-14 of FIG. 13. (Some detail, such as rotation guide track 1132 have been omitted from the view for the sake of clarity.) FIG. 14 shows cap 1104, index 1124, track 1108, front face 1114 and snap fastener 1110. FIG. 14 also shows fulcrum 1136, which causes snap fastener to move in direction C when track 1108 is compressed as shown by arrows 1138.

FIG. 15 shows slider 1106. Slider 1106 may include blades 1142 and 1144. Blades 1142 and 1144 may run in track 1108 (shown in FIG. 11). Blades 1142 and 1144 may correspond to side bays 1128 and 1120 (shown in FIG. 13), respectively. When indicia 1124 (shown in FIG. 13) and 1126 are aligned with each other, blades 1142 and 1144 may be displaced into side bays 1128 and 1120, when track 1108 is compressed as shown by arrows 1138 (shown in FIG. 14).

FIG. 16 shows slider 1106 from behind. Blades 1142 and 1144 may be seen extending down from slider top. Bosses 1148 and 1150 may be present on reverse side 1150 of slider 1106. Bosses 1148 and 1150 may move through rotation guide track 1132 to cause slider 1106 to rotate about axis L₄ (shown in FIG. 13) when a slider 1106 moves in the direction of arrow 1122 (or in the opposite direction).

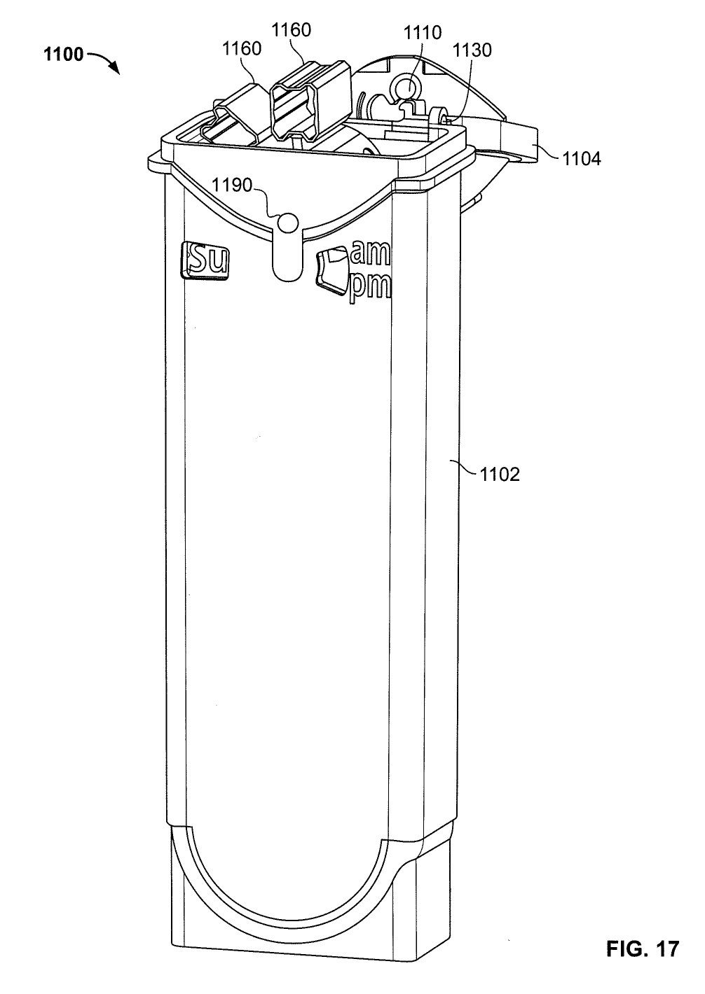

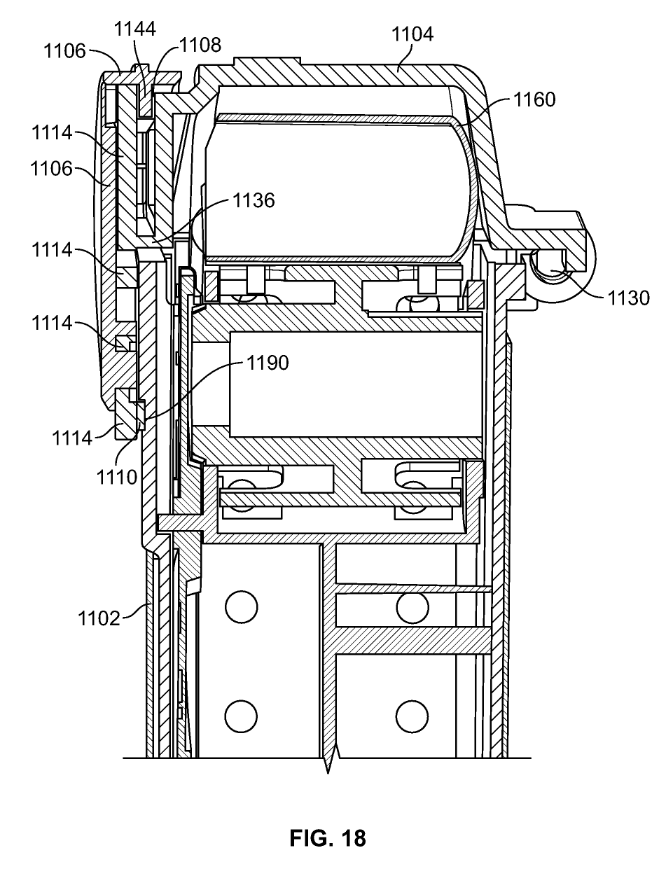

FIG. 17 shows dispenser 1100 with cap 1104 unlocked, open and rotated about hinge 1130. Cap 1104 has sufficient head space to accommodate solid dosage form carriages 1160.

FIG. 18 shows a cross-sectional view taken along lines 18-18 of FIG. 11. FIG. 18 shows cap 1104 in the closed and locked position. Cap 1104 is attached to housing 1102 by hinge 1130. Cap 1104 is locked to housing 1102 by snap fastener 1110, which is engaged with receptacle 1190 in housing 1102. Cap 1104 encloses solid dosage form carriage 1160.

Snap fastener 1110 extends down from slider 1106. Slider 1106 includes blade 1144. Blade 1144 is in track 1108, but is not aligned with a side bay (not present in the cross-sectional view). When blade 1144 is positioned in track 1108, but is not aligned with a side bay, track 1108 cannot be compressed, so snap fastener 1110 cannot be disengaged from housing 11102.

Thus, systems and methods for dispensing solid dosage forms have been provided. Persons skilled in the art will appreciate that the present invention can be practiced by other than the described embodiments, which are presented for purposes of illustration rather than of limitation, and the present invention is limited only by the claims which follow.

What is claimed is:

1. A solid dosage form dispenser comprising:
a housing; and
a cap that is pivotably attached to an open end of the housing such that the cap pivots between a closed position and an open position; and
a snap fastener that is configured to engage the housing to lock the cap in the closed position;
wherein the cap comprises a clearance arch for a solid dosage form carriage, at least a portion of the carriage configured to be supported between the housing and the arch.

2. The solid dosage form dispenser of claim 1 further comprising:
a lever supporting the snap fastener, the lever having a first end proximate the clearance arch and a second end extending away from the clearance arch and supporting the snap fastener;
a fulcrum affixed to the cap and transecting the lever between the first and second end; and
a slidable blocking member configured to selectively interfere with the first end of the lever to prevent disengagement of the snap fastener from the housing.

3. The solid dosage form dispenser of claim 1 wherein the cap comprises a track in which the slidable block blocking member is configured to slide, the track including a bay into which the slidable blocking member may be moved to prevent the slidable blocking member from interfering with the first end of the lever.

4. The solid dosage form dispenser of claim 1 further comprising a blocking member support, the blocking member support maintaining the slidable blocking member in the track.

5. The solid dosage form dispenser of claim 4 wherein the blocking member support is biased away from the bay such that the slidable blocking member at repose is away from the bay and is positioned to interfere with the first end of the lever.

6. The solid dosage form dispenser of claim 5 wherein:
the cap has a front face;
the blocking member support is affixed to the face by a pin that defines an axis of rotation; and
the blocking member support support comprises an operative portion radially away from the axis, the operative portion configured to support the slidable blocking member in the track.

7. A solid dosage form dispenser comprising:
an elongated housing having an opening at an end;
a conveyor belt that is configured to guide at least a portion of a solid dosage form carriage across the opening, the solid dosage form carriage affixed to the conveyor belt, the conveyor belt being subject to a tension; and
a conveyor belt support member that generates the tension.

8. The solid dosage form dispenser of claim 7 wherein the conveyor belt support member is fixed to the housing and stationary with respect to the conveyor belt.

9. The solid dosage form dispenser of claim 7 further comprising a plurality of solid dosage form carriages that are affixed to the conveyor belt.

10. The solid dosage form dispenser of claim 9 wherein each of the solid dosage form carriages is mechanically linked to an adjacent one of the solid dosage form carriages.

11. The solid dosage form dispenser of claim 7 further comprising a dispensing indicator that is advanced by the conveyor belt.

12. A solid dosage form dispenser comprising:
a housing;
a solid dosage form carriage; and
a movable support for supporting the solid dosage form carriage, the movable support attached to the housing and being movable within the housing;
wherein the movable support is indexed to position the solid dosage form carriage at:
a first position in which the solid dosage form carriage is positioned to release only a first solid dosage form; and
a second position in which the solid dosage form carriage is positioned to release a second solid dosage form.

13. The solid dosage form dispenser of claim 12 wherein:
the solid dosage form carriage has a release opening; and
when the solid dosage form carriage is in the first position, the housing is configured to retain the second solid dosage form in the solid dosage form carriage.

14. The solid dosage form dispenser of claim 13 wherein, when the solid dosage form carriage is in the second position, the housing is configured to release the second solid dosage form from the solid dosage carriage.

15. The solid dosage form dispenser of claim 14 wherein:
the housing has a rim; and
when the solid dosage form carriage is in the first position, the rim blocks the portion of the solid dosage form carriage opening.

16. The solid dosage form dispenser of claim 13 wherein:
the solid dosage form carriage has a cross-section that has a first dimension and a second dimension;
the first dimension corresponds to a diameter of the first solid dosage form; and
the second dimension corresponds to a diameter of the second solid dosage form.

17. The solid dosage form dispenser of claim 16 wherein the first dimension and the second dimension are substantially equal.

18. The solid dosage form dispenser of claim 16 wherein the first dimension is greater than the second dimension.

19. The solid dosage form dispenser of claim 12 wherein the movable support is configured to position the solid dosage form carriage at a third position in which the housing blocks release of the first and second solid dosage forms from the solid dosage form carriage.
